(19) United States
(12) Patent Application Publication
(10) Pub. No.: US 2026/0264615 A1
(43) Pub. Date: Sep. 10, 2026

(54) RECTRACABLE STEP ASSEMBLY

(71) Applicant: B & W Custom Truck Beds, Inc., Humboldt, KS (US)

(72) Inventor: Dirk A. Sorenson, Yates Center, KS (US)

(73) Assignee: B & W Custom Truck Beds, Inc., Humboldt, KS (US)

(21) Appl. No.: 19/555,474

(22) Filed: Mar. 3, 2026

Related U.S. Application Data
(60) Provisional application No. 63/766,860, filed on Mar. 4, 2025.

(51) Int. Cl. B60R 3/02

(52) U.S. Cl. CPC B60R 3/02

(57) ABSTRACT

A vehicle-mounted retractable step assembly includes a fixed base and a platform, with the platform movable between an extended position wherein the platform extends out of the fixed base, and a retracted position wherein the platform is received within the base. A biasing element extends between the base and the platform and biases the platform toward the retracted position. The base includes a catch, and the platform includes positioning features that engage the catch to retain the platform in the extended and retracted positions. A guide rod is secured to the platform and extends through a guide channel formed in the base to guide sliding movement of the platform.

### CROSS-REFERENCE TO RELATED APPLICATIONS

This application claims the benefit of U.S. Provisional Patent Application Ser. No. 63/766,860, entitled RECTRACABLE STEP ASSEMBLY, filed March 4, 2025, the disclosure of which is incorporated herein in its entirety by reference.

### FIELD OF THE INVENTION

This invention relates to steps configured to enable access to vehicles, and in particular, to such a step that is selectively extendable and retractable.

### BACKGROUND

Work vehicles, including service vehicles, utility trucks, and heavy-duty pickups, are commonly used to transport tools, equipment, and materials to job sites. These vehicles often feature elevated cargo beds or storage compartments such as vehicle-mounted toolboxes which may be located in hard-to-reach areas, resulting in workers having to frequently climb into and out of the vehicle to retrieve or stow items.

Various step systems have been developed to assist workers in accessing storage areas of the vehicle. Conventional vehicle-mounted steps may be fixed, retractable, foldable, or sliding, and are typically attached to the vehicle’s frame, bumper, or side panel. These steps provide a foothold that reduces the required step height, making it easier and safer for a worker to ascend and descend. Despite the availability of various vehicle-mounted step solutions, existing systems present certain limitations. Some steps are cumbersome to deploy or stow, requiring manual effort that may be inconvenient for a worker carrying tools or materials. Other step systems lack sufficient structural support or stability, particularly when subjected to dynamic loads or uneven terrain. Additionally, certain conventional steps may interfere with ground clearance or vehicle operation when not in use.

Accordingly, there remains a need for an improved work vehicle step system that provides secure, stable support while minimizing deployment effort, maximizing durability, and ensuring compatibility with various configurations of vehicles and storage compartments mounted thereon, such as truck-mounted toolboxes.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a vehicle-mounted step assembly including a base and a platform that slides between a retracted position and an extended position.

A retractable step assembly is provided for accessing a storage area of a vehicle, such as a truck bed or a truck-mounted toolbox. The step assembly includes a fixed base mounted to a vehicle and a platform that is slidable relative to the fixed base between a retracted position, wherein the platform is received within the base, and an extended position, wherein the platform projects outward from the vehicle. A biasing element that extends between the fixed base and the platform urges the platform toward the retracted position. In certain embodiments, the biasing element is an extension spring coupled between a first connection feature formed in or secured to the base and a second connection feature formed in or secured to the platform. The spring may extend through a gap or cutout formed in the platform as the platform moves between the extended and retracted positions.

The base includes one or more catches, and the platform includes corresponding positioning features configured to engage the catches such that the catches and the positioning features cooperate to selectively retain the platform in either the retracted position or the extended position. In certain embodiments, the positioning features are formed on downwardly extending guide beams of the platform and include abutment surfaces that abut against corresponding abutment surfaces of the catches upon engagement of the positioning features and the catches.

Movement of the platform relative to the base may be guided by a guide rod secured to the platform and extending through a corresponding guide channel formed in the base. The guide rod slides within the guide channel as the platform moves between the extended position and the retracted position. The guide channel includes an assembly channel through which the guide rod is inserted during assembly of the step assembly. The platform may further include a front skirt carrying a grip that is graspable by a user to move the platform between the retracted position and the extended position.

### DESCRIPTION OF THE DRAWINGS

Illustrative embodiments of the invention are described in detail below with reference to the attached drawing figures, and wherein:

FIG. 1 is a perspective view of a vehicle equipped with a retractable step assembly in accordance with an embodiment of the invention, viewed from above and to the left and depicted with a platform in an extended position;

FIG. 2 is a perspective view of the retractable step assembly of FIG. 1, viewed from above and to the right and depicted with the platform in a retracted position;

FIG. 3 is a perspective view of the retractable step assembly of FIG. 1, viewed from above and to the right and depicted with the platform in the extended position;

FIG. 4 is a perspective view of the retractable step assembly of FIG. 1, viewed from below and to the right and depicted with the platform in the retracted position;

FIG. 5 is a perspective view of the retractable step assembly of FIG. 1, viewed from below and to the right and depicted with the platform in the extended position;

FIG. 6 is a perspective view of a base of the retractable step assembly of FIG. 1, viewed from above and to the right;

FIG. 7 is a perspective view of the platform of the retractable step assembly of FIG. 1, viewed from below and to the right;

FIG. 8 is a section view of the retractable step assembly of FIG. 1, taken generally along line 8 in FIG. 4, depicting the platform in the retracted position;

FIG. 9 is a section view of the retractable step assembly of FIG. 1, taken generally along line 9 in FIG. 5, depicting the platform in the extended position;

FIG. 10 is a perspective view of an alternative embodiment of the retractable step assembly, viewed from above and to the right and depicted with a platform in a retracted position;

FIG. 11 is a perspective view of the retractable step assembly of FIG. 10, viewed from below and to the right and depicted with the platform in the retracted position.

FIG. 12 is a perspective view of the retractable step assembly of FIG. 10, viewed from above and to the right and depicted with the platform in an extended position;

FIG. 13 is section view of the retractable step assembly of FIG. 10, taken generally along line 13 in FIG. 12, depicting the platform in the extended position.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Directional references may be used herein for convenience in reference only and should not be interpreted in a limiting sense. For example, the words “upwardly,” “downwardly,” “rightwardly,” and “leftwardly” will refer to directions in the drawings to which reference is made, and the words “inwardly” and “outwardly” will refer to directions toward and away from, respectively, the geometric center of the embodiment being described and designated parts thereof. The words “front” or “forward” will refer to the left side of the page of the drawing to which reference is made, and the words “rear” or “rearward” will refer to the right side of the page of the drawing to which reference is made. The words “mounted,” “connected,” “joined,” “attached,” “secured,” or variations thereof will refer to parts, elements, or components that are both formed separately or joined together, as by welding or through a mechanical coupling, or parts, elements, or components that are integrally formed together. The terms “about” or “approximately” as used herein denote deviations from the exact value by +/- 10%, preferably by +/- 5%, and/or deviations in the form of changes that are insignificant to the described function. Said terminology will include the words specifically mentioned, derivatives thereof, and words of a similar import.

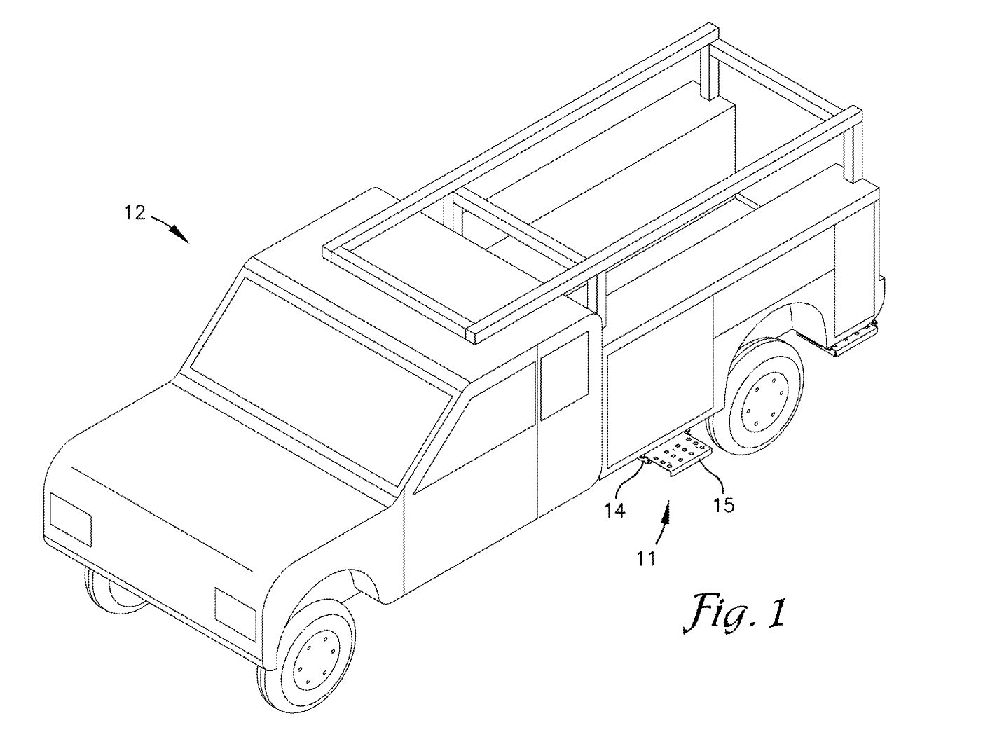

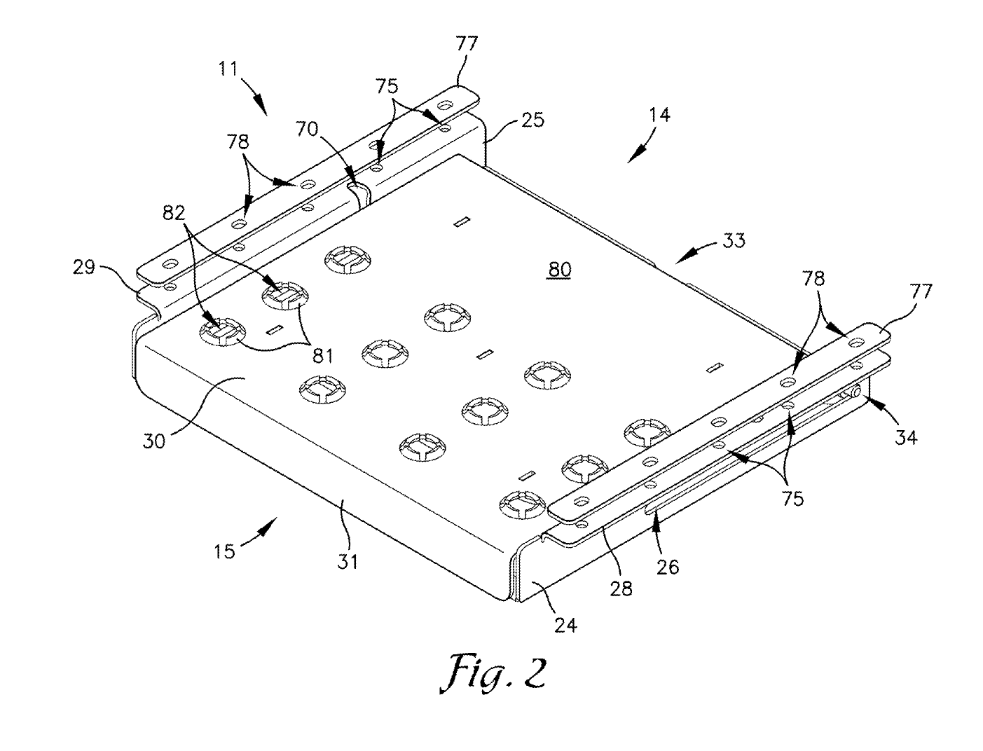

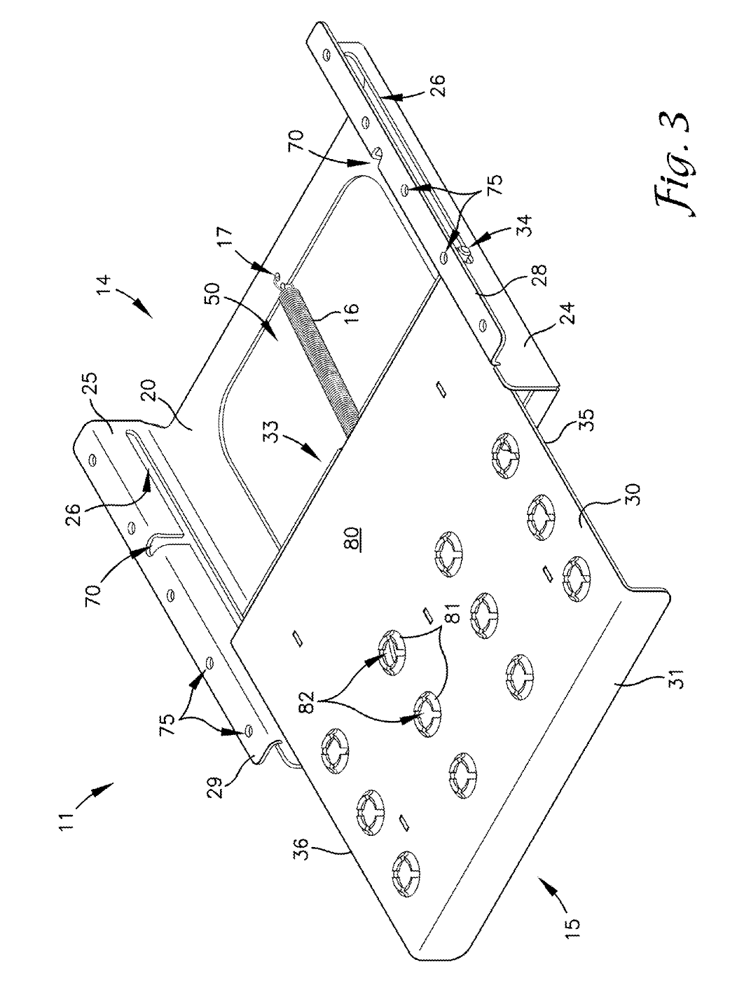

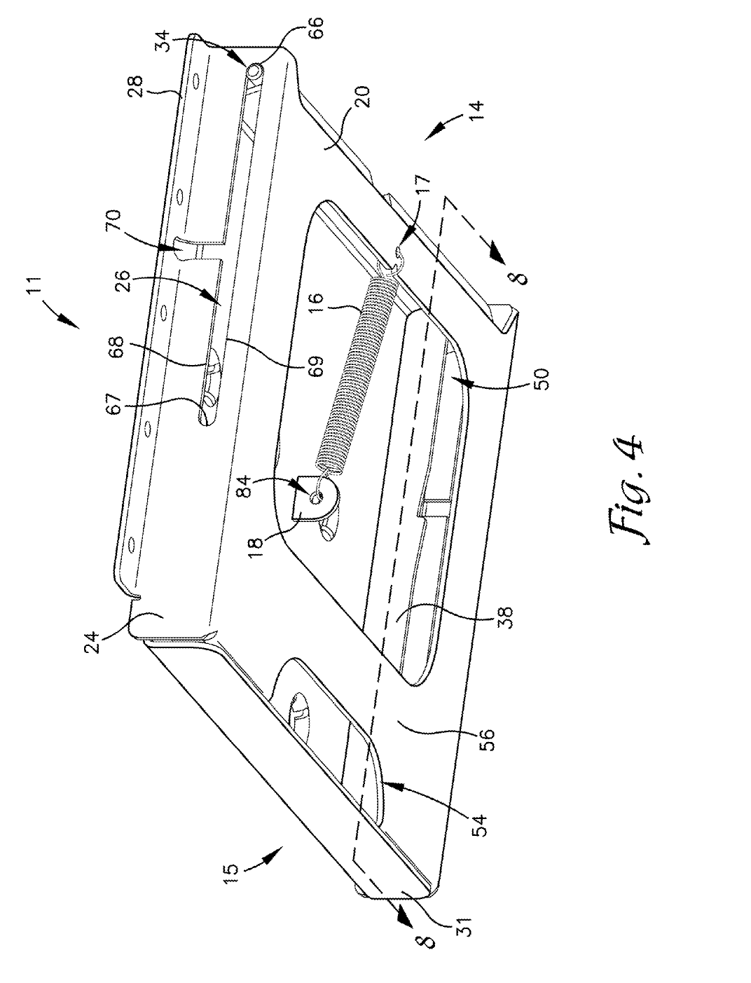

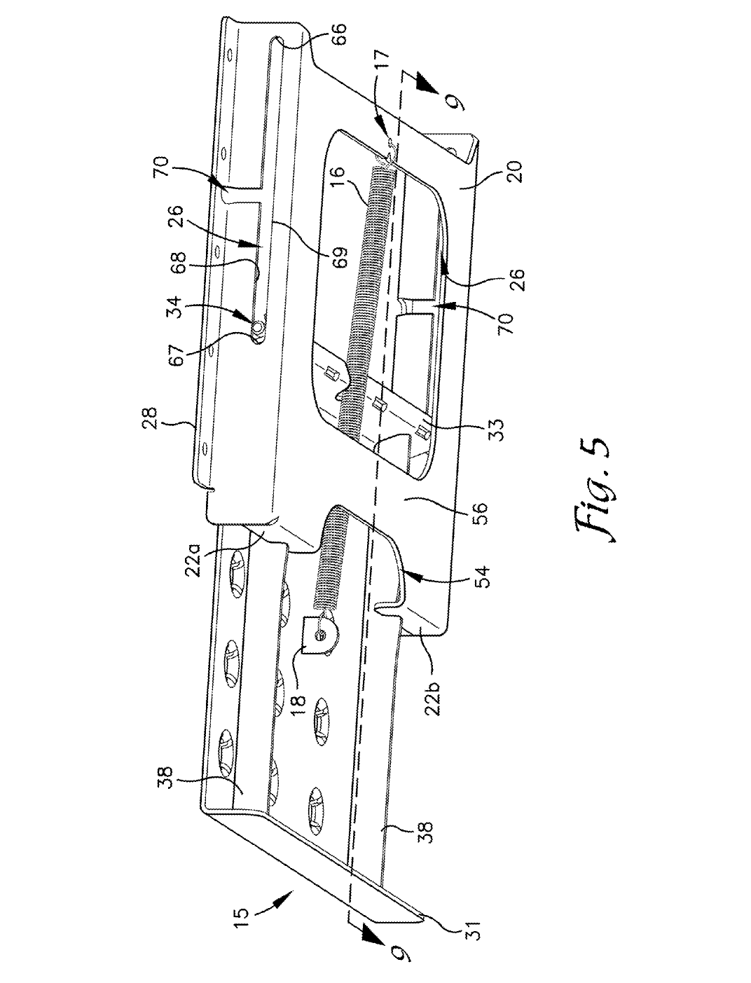

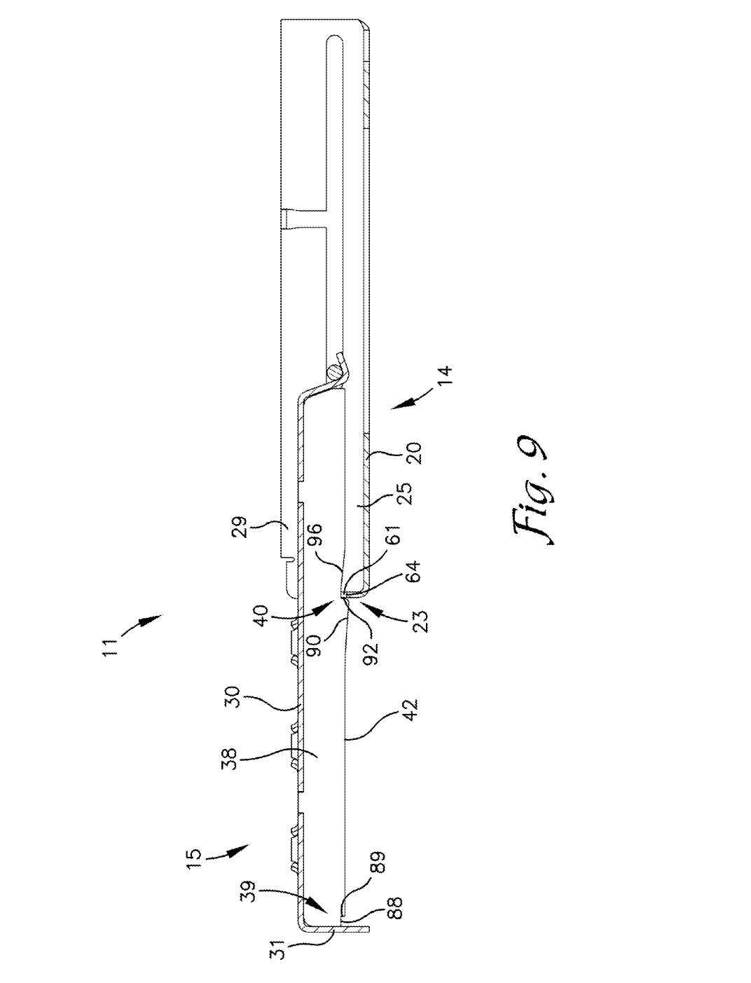

Referring to the drawings in more detail, FIGS. 1-9 show a retractable step assembly 11 configured to be mounted to the bottom of a vehicle 12 or the bottom of a vehicle-mounted toolbox (not shown). The retractable step assembly 11 includes a fixed base or base tray 14 and a sliding platform 15 which slides into and out of the base tray 14 between a retracted position (see FIGS. 2 and 4) and an extended position (see FIGS. 3 and 5). A biasing element 16, shown and described herein as an extension spring 16, extends between a first spring connection feature 17 formed in the base tray 14 and a second spring connection feature 18 extending downward from or formed in the platform 15 and biases the platform 115 to slide to the retracted position.

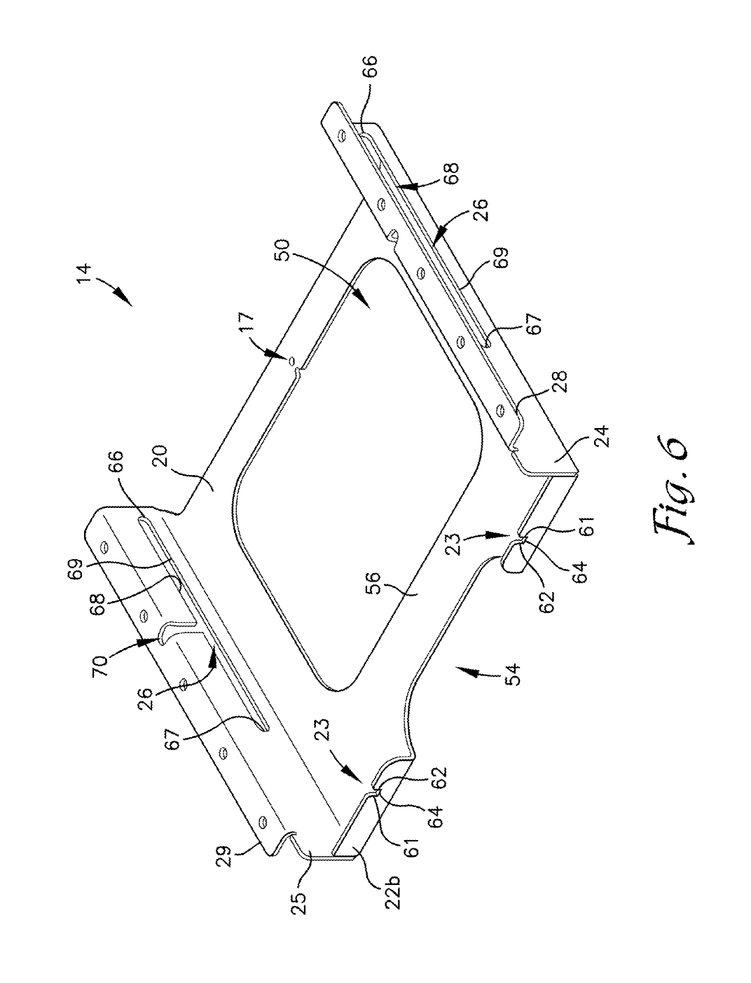

In the embodiment shown and as best seen in FIGS. 5 and 6, the base tray 14 includes a floor plate 20 which extends below the platform 15 and between a pair of upstanding forward walls 22a and 22b in which base positioning features 23 are formed, and a pair of upstanding side walls 24 and 25 in which generally elongate guide channels 26 are formed. Mounting flanges 28 and 29 extend laterally outward from the upper edges of the side walls 24 and 25, respectively, and are configured to allow the base tray 14 to be mounted to the vehicle 12. Referring to FIGS. 2, 3 and 7, the platform 15 includes a step plate 30 which extends above the floor plate 20 of the base tray 14 and extends between a downwardly-extending front skirt 31, a downwardly-extending rear skirt 33 to which a pair of guide rods 34 are secured, and a pair of opposing side edges 35 and 36 which extend slightly inward of the upstanding side walls 24 and 25 of the base tray 14. A pair of guide beams or guide rails 38 extend downward from the underside of the step plate 30 and include first or forward step positioning features 39 and second or rearward step positioning features 40 formed therein which are spaced apart from each other along the lengths of the guide beams 38 by sliding surfaces 42.

The platform 15 is centrally oriented relative to the base tray 14, with an outer end 44 of each guide rod 34 extending within a corresponding channel 26 and each of the base positioning features 23 of the base tray 14 receiving a corresponding one of the guide beams 38 of the platform 15. The outer ends 44 of the guide rods 34 slide within the channels 26 and the sliding surfaces 42 slide within the base positioning features 23, as the platform 15 slides between the retracted position and the extended position, such that when the platform 15 is in the retracted position the first step positioning features 39 thereof matingly engage the base positioning features 23 of the base tray 14, and when the platform 15 is in the extended position the second step positioning features 40 thereof matingly engage the base positioning features 23 of the base tray 14 to hold the base tray 14 in the extended position against the biasing force of the extension spring 16.

As best seen in FIGS. 4 and 5, a relatively large access opening 50 is centrally formed in the floor plate 20 of the base tray 14 providing access to the space between the step plate 30 and the floor plate 20, and to the extension spring 16 extending therein. In the embodiment shown, the first spring connection feature 17 is a hole 17 in which a first end of the spring 16 is received, with the hole 17 formed in the floor plate 20 slightly rearward of the rear edge of the access opening 50. The hole 17 extends in a plane that bisects and extends transverse to the retractable step assembly 11 such that the hole 17 is centrally oriented between the side walls 24 and 25 extending upward from the side edges of the floor plate 20. Although the illustrated first connection feature is a hole, is it entirely within the ambit of exemplary embodiments to provide a first connection feature formed as a tab, protrusion, hook, post, pin, lug, slot, notch, or the like. It should be understood that the formation of the first spring connection feature 17 may vary in correspondence with the structure of the biasing element 16, which may foreseeably comprise a compression spring, torsion spring, gas spring, resilient strap or band, or the like.

The forward walls 22a and 22b which extend upward from the front edge of the floor plate 20 are spaced apart from each other by an offset 54 which extends rearwardly into the floor plate 20 from the front edge thereof a distance sufficient to allow a user’s fingers or toes to extend behind the front skirt 31, thereby allowing the user to easily grab onto the front skirt 31 to lift and pull the platform 15 when sliding the platform 15 from the retracted position to the extended position, and to prevent smashing of the fingers between the front skirt 31 and a front edge of the floor plate 20 when the platform 15 is drawn to the retracted position relative to the base tray 14 by the extension spring 16. A crossmember portion 56 of the floor plate 20 extends laterally between the access opening 50 and the offset 54 to provide structural integrity to the floor plate 20.

As best shown in FIG. 6, the base positioning features of the embodiment shown are catches 23, formed as slots extending downwardly into respective upstanding forward walls 22a and 22b from the upper edges thereof, such that each catch 23 forms a pair of opposing side surfaces 61 and 62 and an upward-facing abutment surface 64 at the bottom of the slot. The opposing side surfaces 61 and 62 of each catch 23 are spaced apart from each other to define the width of the catch 23, which is sized in correspondence with the width of the guide beam 38 received thereby such that the side surfaces of the guide beams 38 extend proximate to the side surfaces 61 and 62 of the catches 23 as the platform 15 slides between the retracted position and the extended position. As will be described in greater detail herein, the abutment surfaces 64 of the catches 23 are configured to abut against corresponding surfaces formed by the first and second step positioning features 39 and 40 of the guide beams 38, which, in the embodiment shown, are first and second recesses 39 and 40 which are formed in and extend upwardly into a respective guide beam 38.

The generally elongate guide channels 26 formed in the upwardly extending side walls 24 and 25 of the base tray 14 extend longitudinally from first or rear ends 66 oriented proximate to the rear edges of the side walls 24 and 25 to second or front ends 67 oriented nearer to the front edges of the side walls 24 and 25 than the rear edges thereof. The height of each guide channel 26 is defined by opposing upper and lower edges 68 and 69 which are spaced apart from each other a distance slightly greater than the diameter of the guide rod 34 extending therein, allowing the outer ends 44 of the guide rods 34 to move slightly upward or downward within the channels 26 upon pivoting of the platform 15 as the platform 15 is advanced between the retracted position and the extended position.

The guide channels 26 include vertically extending entry channels 70 which are positioned between the first and second ends 66 and 67 of the guide channels 26 and extend upward from the upper edges 68 thereof into respective side walls 24 and 25 before turning outward into respective mounting flanges 28 and 29 and extending distances sufficient to allow the outer ends 44 of the guide rods 34 to extend therethrough. During assembly of the retractable step assembly 11, the platform 15 is positioned such that the guide rods 34 secured thereto extend in the same vertical plane as the entry channels 70, and the platform 15 is advanced toward the base tray 14 until the outer ends 44 of the guide rods 34 pass through corresponding entry channels 70 and into their corresponding guide channels 26, at which point the platform 15 is advanced rearward or forward relative to the base tray 14 to slide the outer ends 44 of the guide rods 34 toward the first or second ends 66 or 67 of their respective guide channels 26.

The mounting flanges 28 and 29, which extend laterally outward from the upper edges of the side walls 24 and 25, respectively, include mounting features 75 which correspond to features of the vehicle 12 (or vehicle-mounted toolbox) to which the retractable step assembly 11 is configured to be mounted. In the embodiment shown, the mounting features 75 are a plurality of spaced apart mounting holes 75 configured to receive fasteners such as bolts or screws. The mounting flanges 28 and 29 may be mounted directly to the vehicle 12 or to portions of a vehicle-mounted toolbox, or may cooperate with auxiliary mounting plates 77 to be mounted to the vehicle 12 or vehicle-mounted toolbox. As shown in FIG. 2, the auxiliary mounting plates 77 include mounting holes 78 or other mounting features corresponding to the mounting features 75 of the mounting flanges 28 and 29.

The step plate 30 of the platform 15 extends in a plane extending above the plane in which the floor plate 20 extends and below the plane in which the mounting flanges 28 and 29 extend. The step plate 30 defines a planar stepping surface 80 which supports a user’s foot when the user steps onto the platform 15 to access a truck bed, toolbox, or other cargo or storage area of a vehicle 12 equipped with the retractable step assembly 11. The stepping surface 80 includes a plurality of traction elements 81 which engage the foot of a user as the user steps onto the stepping surface 80. In the embodiment shown in FIGS. 1-9, the traction elements 81 are lips 81 which protrude upward from the stepping surface 80, with each lip 81 surrounding an aperture 82 formed within the stepping surface 80. Although the traction elements are shown and described herein as upwardly-projecting lips, it is entirely within the ambit of exemplary embodiments to provide other configurations of elements that enhance traction and mitigate the risk of a user slipping when stepping onto the stepping surface, including slip-resistant materials such as rubber or textured structures such as bosses, ribs, treads, or grooves to enhance traction and mitigate the risk of a user slipping when stepping thereon.

Referring to FIGS. 4 and 5, in the embodiment shown, the second spring connection feature 18 is a tab 18 which extends downward from the underside of the step plate 30 and has a hole 84 formed therein, with the hole 84 sized to receive a second end of the extension spring 16. The tab 18 extends in a plane that bisects and extends transverse to the retractable step assembly 11, with the tab 18 centrally oriented between the guide rails 38 of the platform 15 and extending in the same central plane as the hole 17. It is foreseen that the second spring connection feature may be formed as a hole, protrusion, hook, post, pin, lug, slot, notch, or the like. The second spring connection feature 18 is positioned forward and upward of the first spring connection feature 17, such that the extension spring 16 extending through the space oriented between the floor plate 20 and the step plate 30 and connected to the first spring connection feature 17 and the second spring connection feature 18 extends at an angle which is more severe when the platform 15 is in the retracted position and less severe when the platform 15 is in the extended position.

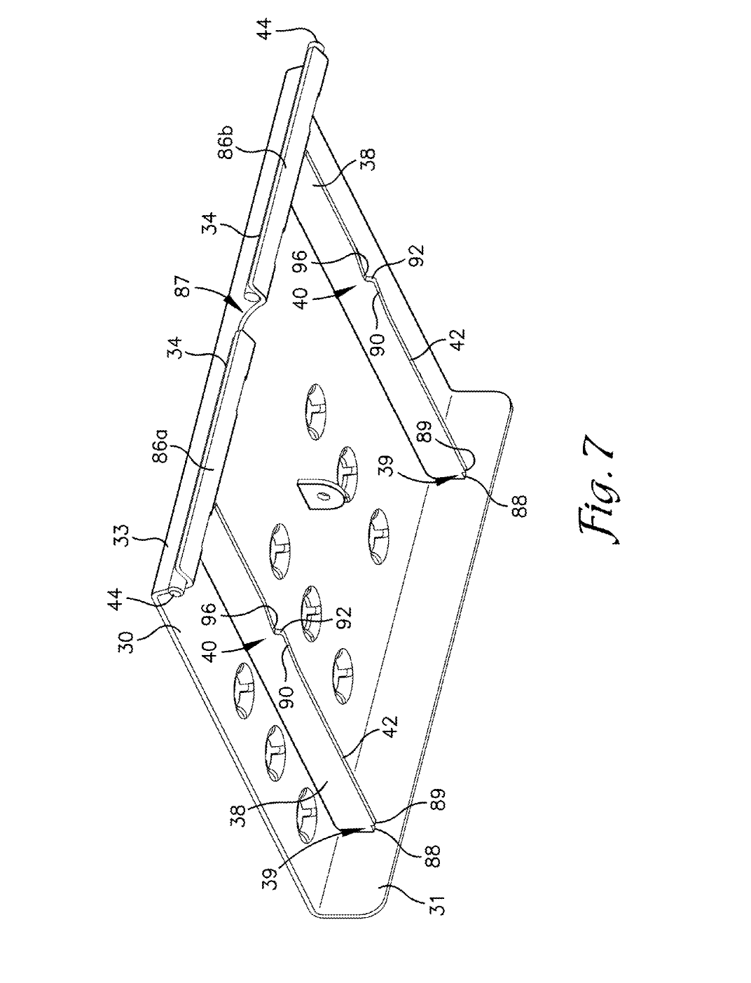

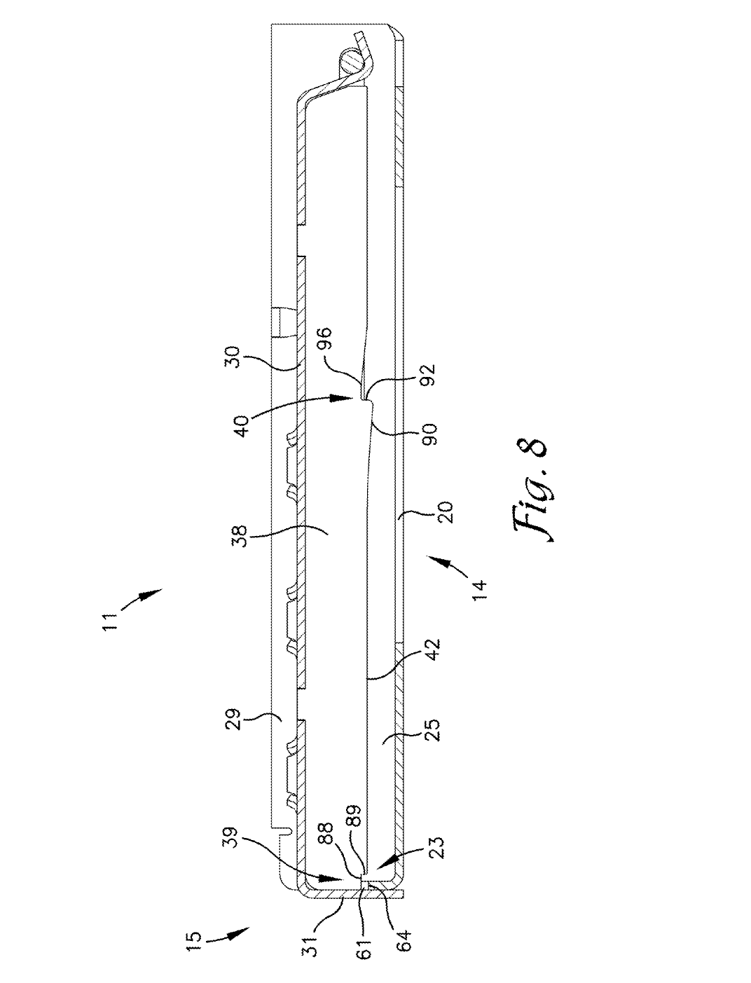

The front skirt 31 of the platform 15 extends downward from the front edge of the step plate 30 in approximately orthogonal relation thereto, such that when the platform 15 is in the retracted position, as shown in FIG. 8, the front skirt 31 extends slightly in front of the forward walls 22a and 22b and the offset 54 extending therebetween. Referring to FIG. 7, the rear skirt 33 of the platform 15 extends downward and rearward from the rear edge of the step plate 30 before turning to extend slightly upward and further rearward, forming a pair of rod supports 86a and 86b to which the guide rods 34 are respectively secured. The rod supports 86a and 86b and the guide rods 34 secured thereto are spaced apart from each other by a spring cutout or gap 87 formed in the rear skirt 33 and sized to receive the extension spring 16, such that the extension spring 16 extends through the spring gap 87 when the platform 15 is in the extended position. The inner ends of the guide rods 34 extend adjacent to the opposing edges of the spring gap 87, with the guide rods 34 extend outward therefrom along the rod supports 86a and 86b to their respective outer ends 44, which extend slightly outward of the guide channels 26 formed in the upstanding side walls 24 and 25.

The guide rods 34 slide within the guide channels 26 as the platform 15 slides between the retracted position and the extended position, such that when the platform 15 is in the retracted position (see FIGS. 2 and 4) the outer ends 44 of the guide rods 34 extend proximate to the rear ends 66 of the guide channels 26, and when the platform 15 is in the extended position (see FIGS. 3 and 5) the outer ends 44 of the guide rods 34 extend proximate to the front ends 67 of the guide channels 26. As noted previously, the distance between the upper and lower edges 68 and 69 of the guide channels 26 is slightly greater than the diameter of the guide rods 34, allowing for slight vertical movement of the guide rods 34 within the guide channels 26 as the platform 15 pivots while sliding between the retracted position and the extended position.

As shown in FIGS. 7-9, the guide rails 38 extend downward from the underside of the step plate 30 and between the front and rear skirts 31 and 33 of the platform 15. The guide rails 38 extend in respective planes extending approximately orthogonal to the plane in which the step plate 30 extends, with each of the respective guide rails 38 extending through a corresponding catch 23 formed in a forward wall 22a or 22b of the base tray 14 such that each guide rail 38 can be said to extend coplanar with a corresponding catch 23. The guide rails 38 are slightly narrower than the catches 23, with the side surfaces of each guide rail 38 extending proximate to the opposing side surfaces 61 and 62 of the respective catch 23 extending coplanar therewith.

The first step positioning features 39 are formed in the guide rails 38 just behind the front skirt 31 of the platform 15, with the first step positioning features 39 extending rearward into the guide rails 38 from the front edges thereof to form downward-facing abutment surfaces 88 before turning downward to form forward-facing limiting surfaces 89. When the platform 15 is in the retracted position, with the forward step positioning features 39 matingly received in the catches 23, the abutment surfaces 88 of the first step positioning features 39 are supported on the abutment surfaces 64 of the catches 23, the front skirt 31 extends just forward of the upstanding forward walls 22a and 22b, and the limiting surfaces 89 of the first step positioning features 39 extend just rearward of the upstanding forward walls 22a and 22b such that the platform 15 is generally fixed in the retracted position and cannot be moved forward, rearward, downward, or side-to-side relative to the base tray 14.

The sliding surfaces 42 of the guide beams 38 extend rearwardly from the limiting surfaces 89 of the forward step positioning features 39 in a plane extending generally parallel to the plane in which the step plate 30 of the platform 15 extends, before angling slightly downward to form sloped cam portions 90, with the sloped cam portions 90 extending downward from the sliding surfaces 42 a distance sufficient to securely hold the platform 15 in place upon advancement to the extended position. The rearward step positioning features 40 are formed in the guide beams 38 just behind the sloped cam portions 90 of the sliding surfaces 42 and include a recess extending upward into the guide beams 38 to form rearward-facing limiting surfaces or shoulders 92, before turning sharply and extending rearward to form downward-facing abutment surfaces 96, which extend in approximately the same plane as the downward-facing abutment surfaces 88 of the forward step positioning features 39 before angling slightly downward and extending rearward toward the rear skirt 33. When the platform 15 is in the extended position with the rearward step positioning features 40 matingly received in the base positioning features or catches 23, the abutment surfaces 96 of the rearward step positioning features 40 abut downwardly against the abutment surfaces 64 of the base positioning features 23 and the limiting surfaces 92 extend just forward of the upstanding forward walls 22a and 22b such that the platform 15 is generally fixed in the extended position.

To slide the platform 15 from the retracted position to the extended position, the front skirt 31 of the platform 15 is lifted upward to disengage the forward step positioning features 39 from the base positioning features 23 such that the abutment surfaces 88 separate from the abutment surfaces 64 and the lower edges of the limiting surfaces 89 are positioned upward of the plane in which the abutment surfaces 64 extend. With the limiting surfaces 89 of the first step positioning features 39 clear of the abutment surfaces 64 of the base positioning features 23, the platform 15 is pulled out of the base tray 14 with the sliding surfaces 42 sliding along the abutment surfaces 64 and through the base positioning features 23, and the outer ends 44 of the guide rods 34 departing from the rear ends 66 of their respective guide channels 26 and moving toward the front ends 67 thereof. It should be understood that pulling the platform 15 out of the base tray 14 causes the spring 16 extending between the first spring connection feature 17 of the base tray 14 and the second spring connection feature 18 of the platform 15 to correspondingly extend, with the pulling force of the spring 16 acting upon the platform 15 to bias the platform 15 to the retracted position.

As the platform 15 is pulled further out of the base tray 14 and against the force of the extension spring 16, the extension spring 16 extends through the spring gap 87 formed in the rear skirt 33 and the sloped cam portions 90 of the sliding surfaces 42 slide along the abutment surfaces 64 and through the catches 23 until the outer ends 44 of the guide rods 34 extend proximate to the front ends 67 of their respective guide channels 26 and the rearward-facing limiting surfaces 92 of the second step positioning features 40 extend in a plane extending just forward of the plane in which the upstanding forward walls 22a and 22b extend. With the platform 15 so oriented relative to the base tray 14, the spring 16 urges the platform 15 downward such that the abutment surfaces 96 of the second step positioning features 40 abut against the abutment surfaces 64 of the catches 23, and the limiting surfaces 92 extend just forward of the upstanding forward walls 22a and 22b. With the second step positioning features 40 thereby matingly received in the catches 23, the platform 15 is in the extended position allowing a user to step onto the stepping surface 80 of the platform 15 to access a truck bed, toolbox, or other cargo or storage area of the vehicle 12 to which the retractable step assembly 11 is mounted.

To slide the platform 15 from the extended position to the retracted position, the front skirt 31 of the platform 15 is lifted upward to disengage the rearward step positioning features 40 from the catches 23 such that the abutment surfaces 96 are separated from the abutment surfaces 64 and the lower edges of the limiting surfaces 92 extend upward of the plane in which the abutment surfaces 64 extend. With the limiting surfaces 92 of the rearward step positioning features 40 clear of the abutment surfaces 64 of the catches 23, the extension spring 16 pulls the platform 15 into the base tray 14 such that the sloped cam portions 90 of the sliding surfaces 42 slide along the abutment surfaces 64 and through the catches 23, and the outer ends 44 of the guide rods 34 depart from the front ends 67 of their respective guide channels 26 and move toward the rear ends 66 thereof.

As the extension spring 16 pulls the platform 15 further into the base tray 14, the spring gap 87 passes over the extension spring 16 and the sliding surfaces 42 of the guide beams 38 slide along the abutment surfaces 64 and through the catches 23 until the outer ends 44 of the guide rods 34 extend proximate to the rear ends 66 of their respective guide channels 26 and the forward-facing limiting surfaces 89 of the first step positioning features 39 extend in a plane extending just rearward of the plane in which the upstanding forward walls 22a and 22b extend. With the platform 15 so oriented relative to the base tray 14, the platform 15 is urged downward such that the abutment surfaces 88 of the first step positioning features 39 abut against the abutment surfaces 64 of the catches 23, and the front skirt 31 of the platform 15 and the limiting surfaces 89 of the first step positioning features 39 extend just forward and just rearward, respectively, of the upstanding forward walls 22a and 22b. With the forward step positioning features 39 thereby matingly engaging the catches 23, the platform 15 is in the retracted position and does not create a tripping hazard or otherwise interfere with workers moving around the vehicle 12 to which the retractable step assembly 11 is mounted.

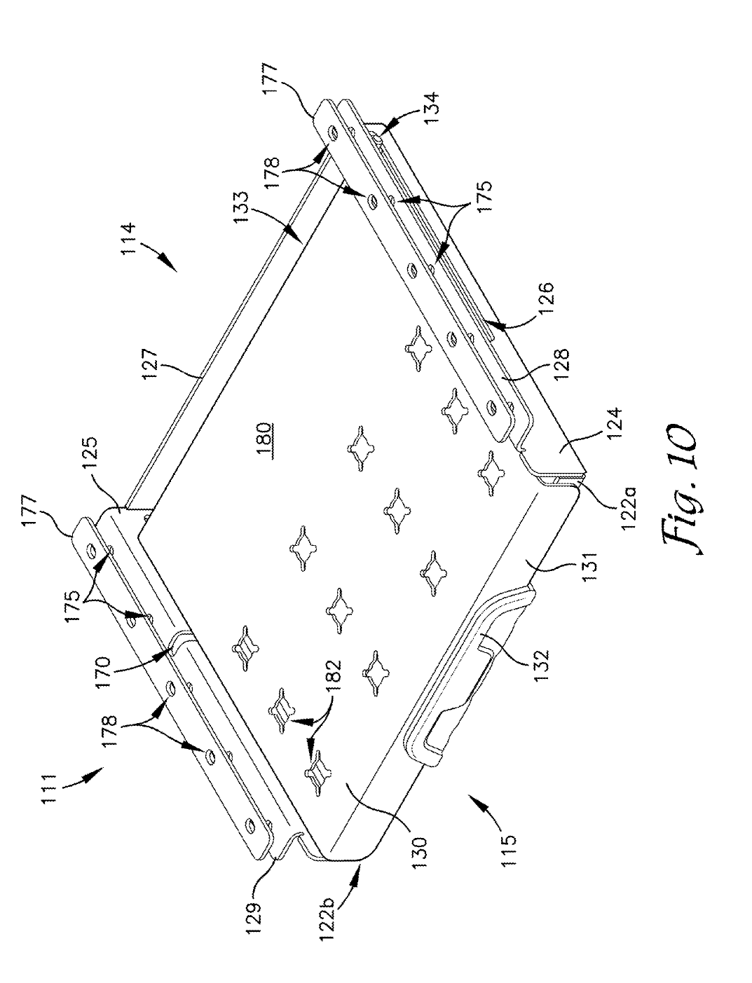

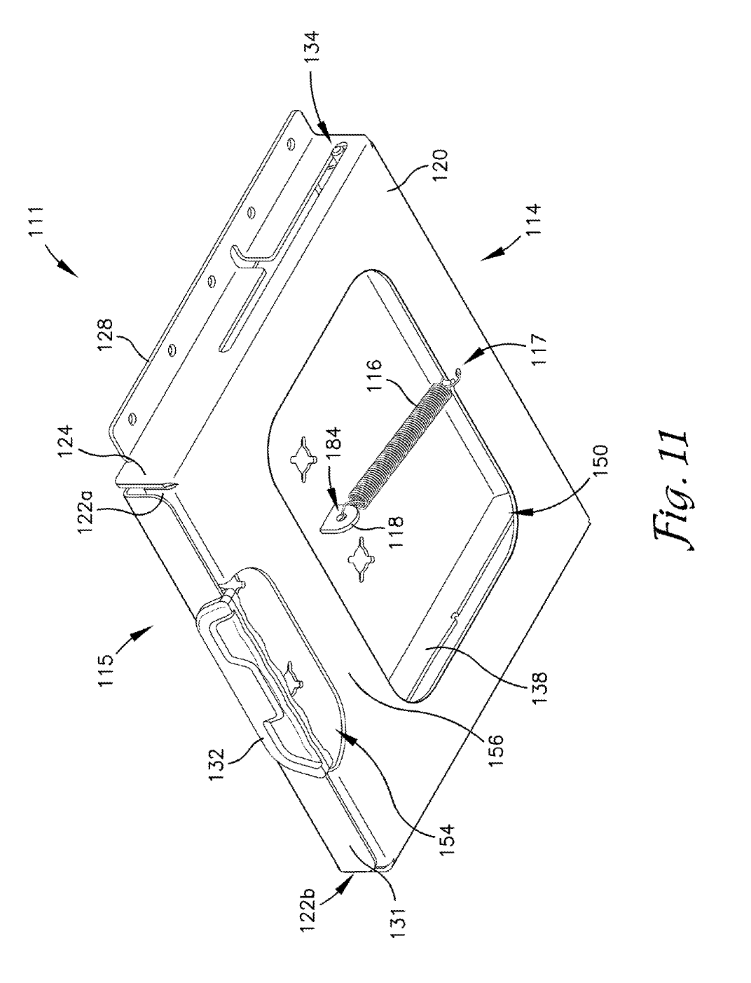

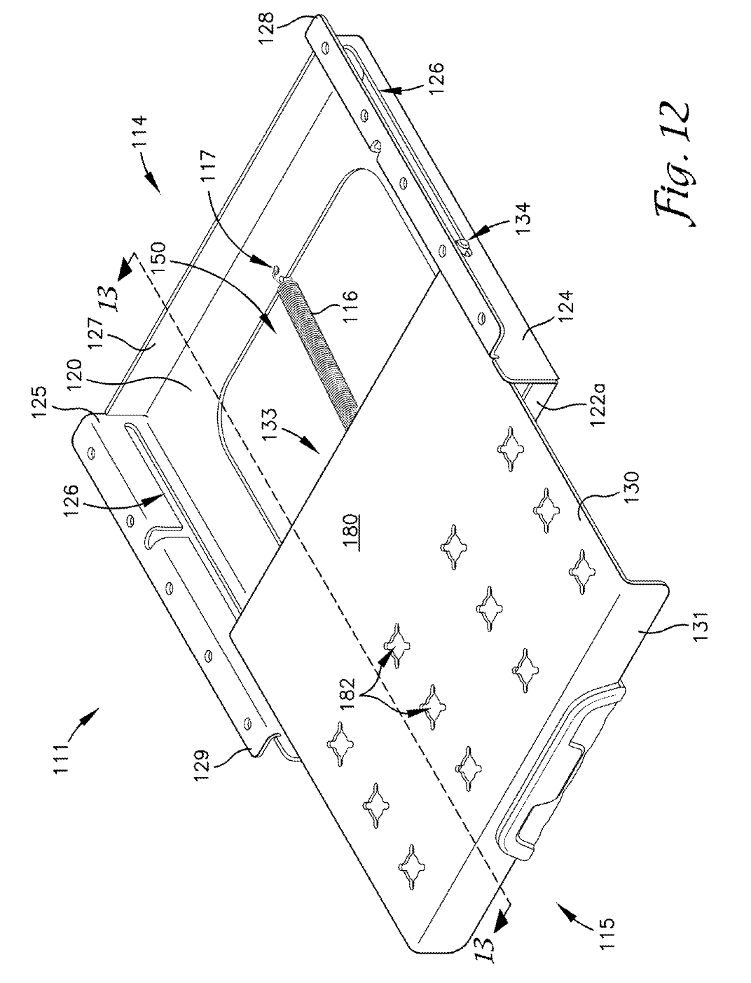

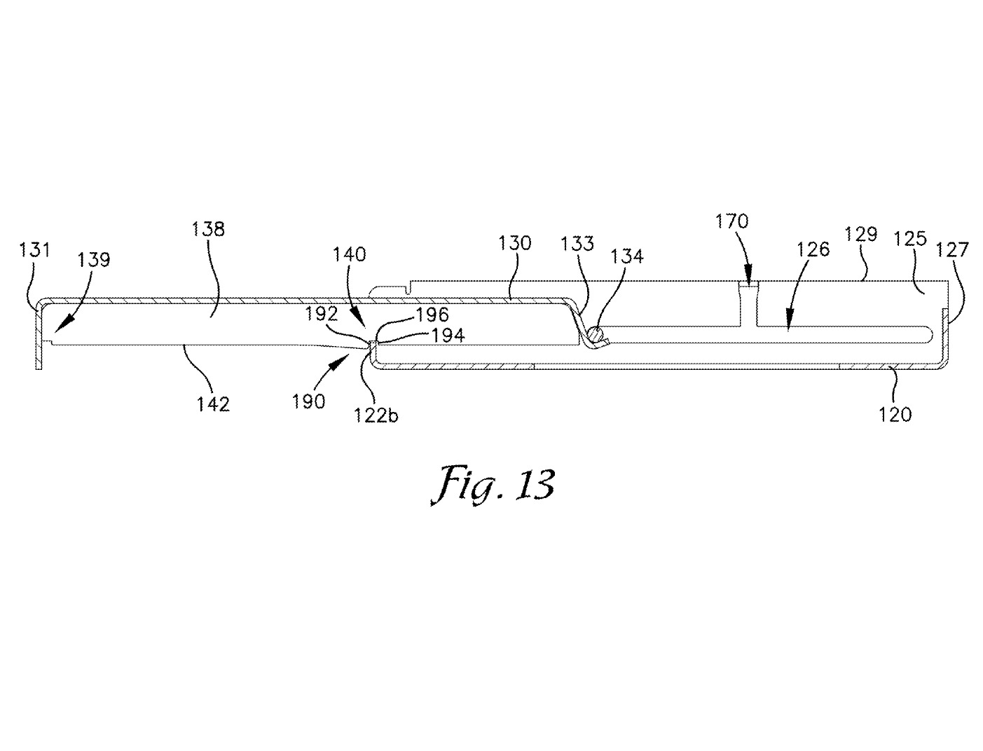

FIGS. 10-13 depict an alternative embodiment of the retractable step assembly, which is denominated herein as retractable step assembly 111. Like the retractable step assembly 11, the retractable step assembly 111 is configured to be mounted to a vehicle 12 or a vehicle-mounted toolbox and includes a base tray 114 and a platform 115 which slides into and out of the base tray 114 between a retracted position (see FIGS. 10 and 11) and an extended position (see FIGS. 12 and 13). The base tray 114 and the platform 115 include generally the same features as the base tray 14 and the platform 15 described above and are oriented relative to each other in the same manner, with a biasing element 116 (e.g., an extension spring 116) extending between first and second spring connection features 117 and 118 such that the biasing element 116 biases the platform 115 to the retracted position.

The base tray 114 includes a floor plate 120 extending between a pair upstanding front walls 122a and 122b in which base positioning features 123 are formed, a pair of upstanding side walls 124 and 125 in which guide channels 126 are formed, and an upstanding rear wall 127. The rear wall 127 extends between the side walls 124 and 125 to mitigate bending or flexing of the base tray 114 during use of the retractable step assembly 111. Mounting flanges 128 and 129 are provided to enable mounting of the base tray 114 to the vehicle 12. The platform 115 includes a step plate 130 extending between a front skirt 131, which carries a handle or grip 132 secured thereto, and a rear skirt 133 to which guide rods 134 are secured, with the guide rods 134 extending through respective guide channels 126. Guide beams or guide rails 138 extend downward from the step plate 130, with each guide beam 138 including first or forward and second or rearward step positioning features 139 and 140 which are spaced apart from each other by sliding surfaces 142. The first and second step positioning features are matingly engageable with the base positioning features 123 to retain the platform 115 in the retracted position or the extended position.

As best shown in FIG. 11, an access opening 150 formed in the floor plate 120 provides access to the space formed between the step plate 130 and the floor plate 120, and to the extension spring 116 extending therein. The forward walls 122a and 122b of the base tray 114 are spaced apart from each other by a grip offset 154 into which the grip 132 formed on the front skirt 131 of the platform 115 extends when the platform 115 is in the retracted position. The grip offset 154 extends rearwardly into the floor plate from the front edge thereof a distance sufficient to allow a user’s fingers or toes to extend behind the grip 132, thereby allowing the user to easily grasp onto the grip 132 to lift and pull the platform 115 when sliding the platform 115 from the retracted position to the extended position, and to prevent smashing of the fingers between the grip 132 and a front edge of the floor plate 120 when the platform 115 is drawn to the retracted position relative to the base tray 114 by the extension spring 116. A crossmember portion 156 of the floor plate 120 extends laterally between the access opening 150 and the grip offset 54 to provide structural integrity to the floor plate 120.

The front skirt 131 of the platform 115 extends downward from the front edge of the step plate 130 in approximately orthogonal relation thereto, such that when the platform 115 is in the retracted position, as shown in FIGS. 10 and 11, the front skirt 131 extends slightly in front of the forward walls 122a and 122b and the grip offset 154 extending therebetween. The grip 132 is secured to a central portion of the front skirt 131, with the length of the grip 132 corresponding to the length of the offset 154. The grip 132 fits over the lower edge of the front skirt 131 such that a front portion of the grip 132 extends along the front face of the skirt 131 and a rear portion of the grip 132 extends along the rear face of the skirt 131.

Referring to FIG. 10, the guide channels 126 include entry channels 170 which extend upward into the side walls 124 and 125 before turning outward into the respective mounting flanges 128 and 129. The entry channels 170 extend sufficiently into the flanges 128, 129 to allow the guide rods 34 to extend therethrough, thereby enabling the platform 115 to be assembled into the base tray 114. The mounting flanges 128 and 129 include mounting features 175 which correspond to features of the vehicle 12 to which the retractable step assembly 111 is mountable. The mounting features 175 are shown and described herein as a plurality of spaced apart fastener-receiving holes 175. It should be understood that the mounting flanges 128 and 129 may be mounted directly to the vehicle 12 or a vehicle-mounted toolbox. Alternatively, the mounting flanges 128 and 129 may cooperate with auxiliary mounting plates 177 and mounting features 178 formed therein to facilitate mounting of the retractable step assembly 111 to the vehicle 12.

The step plate 130 defines a planar stepping surface 180 on which a user places his or her foot when stepping onto the platform 115 to access a truck bed, toolbox, or other cargo or storage area of the vehicle 12. As best shown in FIGS. 10 and 12, the stepping surface 180 is generally flat and includes a plurality of holes 182 formed therein. It is foreseen that the stepping surface 180 may include slip-resistant materials such as rubber or textured structures such as bosses, ribs, treads, or grooves to enhance traction and mitigate the risk of a user slipping when stepping thereon.

Referring to FIG. 13, the sliding surfaces 142 of the guide rails 138 extend rearwardly from the forward positioning features 139 in a plane extending generally parallel to the plane in which the step plate 130 of the platform 115 extends, before angling slightly downward to form sloped cam portions 190. The rearward positioning features 140 formed in the guide rails 138 are oriented just behind the sloped cam portions 190 and extend upward into the guide rails 138 to form opposing rearward-facing and forward-facing limiting surfaces 192 and 194 and downward-facing abutment surfaces 196 extending therebetween. When the platform 115 is in the extended position with the rearward positioning features 140 matingly engaging the base positioning features 123, the abutment surfaces 196 of the rearward positioning features 140 abut against corresponding surfaces of the base positioning features 123 and the limiting surfaces 192 and 194 extend just forward and just rearward, respectively, of the upstanding forward walls 122a and 122b such that the platform 115 is generally fixed in the extended position and cannot be moved relative to the base tray 114.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of the disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device assembly including one or more of the elements at issue. Similarly, references to first and second elements, or to a pair of elements, is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

1. A step assembly for accessing a storage area of a vehicle, the step assembly comprising:
a fixed base mounted to the vehicle;
a platform slidable between an extended position wherein the platform extends outward relative to the fixed base and beyond an edge of the vehicle, and a retracted position wherein the platform extends within the fixed base; and
a biasing element extending between the fixed base and the platform, the biasing element biasing the platform toward the retracted position.

2. The step assembly as in claim 1, wherein the biasing element is an extension spring.

3. The step assembly as in claim 1, wherein the biasing element extends between a first connection feature of the fixed base and a second connection feature of the platform.

4. The step assembly as in claim 3, wherein the first connection feature and the second connection feature extend in a central plane of the step assembly.

5. The step assembly as in claim 1, wherein the biasing element extends through a gap formed in the platform when the platform is in the extended position.

6. The step assembly as in claim 1, further comprising a guide beam extending downward from the platform, the guide beam sliding along a catch of the fixed base as the platform slides between the extended position and the retracted position.

7. The step assembly as in claim 1, further comprising a guide rod secured to the platform, the guide rod extending through a guide slot formed in the fixed base, the guide rod movable within the guide slot as the platform slides between the extended position and the retracted position.

8. The step assembly as in claim 1, wherein the platform includes a front skirt carrying a grip graspable to slide the platform between the extended position and the retracted position.

9. The step assembly as in claim 8, wherein an offset is formed in the fixed base, the offset sized to receive the grip when the platform is in the retracted position.

10. A retractable step assembly mounted to a vehicle, the retractable step assembly comprising:
a base tray having a base positioning feature;
a platform movable relative to the base tray between an extended position and a retracted position, the platform having a first step positioning feature and a second step positioning feature; and
a spring extending between the base tray and the platform, the spring biasing the platform toward the retracted position;
wherein the first step positioning feature engages the base positioning feature to retain the platform in the retracted position, and the second step positioning feature engages the base positioning feature to retain the platform in the extended position.

11. The retractable step assembly as in claim 10, wherein an abutment surface of the first step positioning feature abuts against an abutment surface of the base positioning feature when the platform is in the retracted position, and an abutment surface of the second step positioning feature abuts against the abutment surface of the base positioning feature when the platform is in the extended position.

12. The retractable step assembly as in claim 10, wherein the base positioning feature is a catch formed in an upstanding wall of the base tray.

13. The retractable step assembly as in claim 10, wherein the first step positioning feature and the second step positioning feature are formed in a guide rail of the platform.

14. The retractable step assembly as in claim 13, wherein the guide rail includes a sliding surface extending between the first step positioning feature and the second step positioning feature.

15. The retractable step assembly as in claim 13, wherein the guide rail is a pair of guide rails and the base positioning feature is a pair of base positioning features, each of the pair of guide rails slidable along a respective one of the pair of base positioning features.

16. A retractable step for a vehicle, the retractable step comprising:
a fixed base mounted to the vehicle and having a guide channel formed therein;
a platform sized to be received within the fixed base and advanceable relative to the fixed base between an extended position and a retracted position;
a biasing element extending between the fixed base and the platform, the biasing element pulling the platform toward the retracted position; and
a guide rod secured to the platform and extending through the guide channel, the guide rod sliding through the guide channel as the platform is advanced between the extended position and the retracted position.

17. The retractable step as in claim 16, wherein the guide rod extends proximate a first end of the guide channel when the platform is advanced to the retracted position, and the guide rod extends proximate a second end of the guide channel when the platform is advanced to the extended position.

18. The retractable step as in claim 16, wherein the guide channel is a pair of guide channels and the guide rod is a pair of guide rods, each of the pair of guide channels formed in a respective side wall of the fixed base, each of the pair of guide rods extending through a respective one of the pair of guide channels.

19. The retractable step as in claim 18, wherein the biasing element is extendable through a cutout formed in the platform, the cutout oriented between the pair of guide rods.

20. The retractable step as in claim 16, wherein the guide rod is advanced through an assembly channel and into the guide channel to assemble the retractable step.
